(19) United States
(12) Patent Application Publication
(10) Pub. No.: US 2015/0340131 A1
(43) Pub. Date: Nov. 26, 2015

(54) Armadillo Equipment

(71) Applicant: Eduardo Ferreira Loures, (US)

(72) Inventor: Eduardo Ferreira Loures, Belo Horizonte (BR)

(73) Assignee: Eduardo Ferreira Loures, Belo Horizonte (BR)

(21) Appl. No.: 14/263,125

(22) Filed: May 26, 2014

(51) Int. Cl. H01B 13/004; H05B 6/02; H01B 13/32; H01B 13/00

(52) U.S. Cl. CPC H01B 13/004; H01B 13/0036; H05B 6/02; H01B 13/32

(57) ABSTRACT

There are many applications in which coating a cylindrical hole with metallic material is required to form a continuous cylindrical tube. An equipment was designed to easily produce a seamless metallic coating on a cylindrical hole with uniform diameter. The coat is produced directly on the inner surface of the hole and it can be done while drilling.

### TECHNICAL FIELD

Electronics, electrical engineering and electrical devices, mechanical and thermal engineering.

### BRIEF DESCRIPTION OF DRAWINGS

FIG. 1 is the part of the equipment that works underground. It contains six sectional views (A, B, C, D, E, F) upon which the plane is indicated by a broken line on the view from which a different module of the equipment is cut. This figure also contains two partial views (G, H) created for magnification purposes.

FIG. 1A is the sectional view (plane A-A) of FIG. 1 and represents the Support and Traction unit.

FIG. 1B is the sectional view (plane B-B) of FIG. 1 and represents the Energy Feeder unit.

FIG. 1C is the sectional view (plane C-C) of FIG. 1 and represents the Flatting module.

FIG. 1D is the sectional view (plane D-D) of FIG. 1 and represents the Double Helical Induction Continuous Furnace module.

FIG. 1E is the sectional view (plane E-E) of FIG. 1 and represents the Alloy Ejection module.

FIG. 1F is the sectional view (plane F-F) of FIG. 1 and represents the Monitoring and Control unit.

FIG. 1G is the partial view G of FIG. 1 and represents a magnification of part of the Energy, Flatting and Induction Furnace modules.

FIG. 1H is the partial view H of FIG. 1 and represents a magnification of part of the Furnace, Alloy Ejection and Monitoring and Control modules.

FIG. 2 is the Support and Traction unit that works on the ground or on a platform.

FIG. 2A is the sectional view (plane A-A) of FIG. 2.

FIG. 3 is the Energy Feeder and Control unit that works on the ground or on a platform.

FIG. 4 is the Alloy Feeder unit that works on the ground or on a platform.

FIG. 5 shows the Conductor Launching Equipment.

FIG. 5A is the side view of a reel with its concentric holes.

FIG. 6 is the metal alloy ring for process initialization.

FIG. 6A is the sectional view (plane A-A) of FIG. 6.

FIG. 7 is a 3D illustration of the helical induction furnace and its winding.

### DESCRIPTION OF EMBODIMENTS

There are many applications in which coating a cylindrical hole with metallic material is required to form a continuous cylindrical tube. An equipment was designed to easily produce a seamless metallic coating on the inner surface of a previously made cylindrical hole with uniform diameter.

The Armadillo Equipment, codenamed Armadillo, has a modular design. The modules are assembled to comply with a specific configuration. They are mechanically and electrically connected resulting in a cylindrical equipment. A steel set (frame and base) is responsible for the structural strength of the whole equipment.

The Armadillo basic function is to produce a continuous and uniform metallic coating on a previously made underground cylindrical hole.

There is an annulus space in the center of the Armadillo that runs along the entire equipment with the same inner diameter. It is needed for the continuous tubular coating process described below.

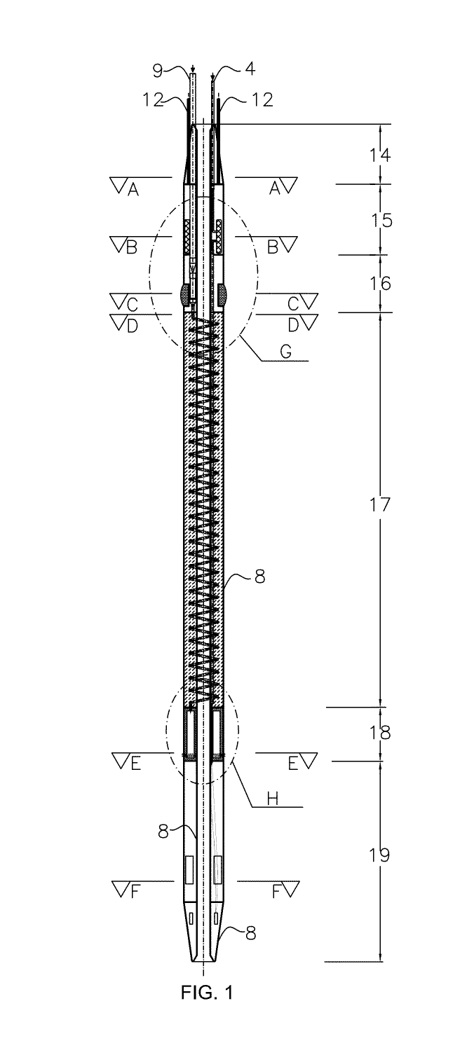

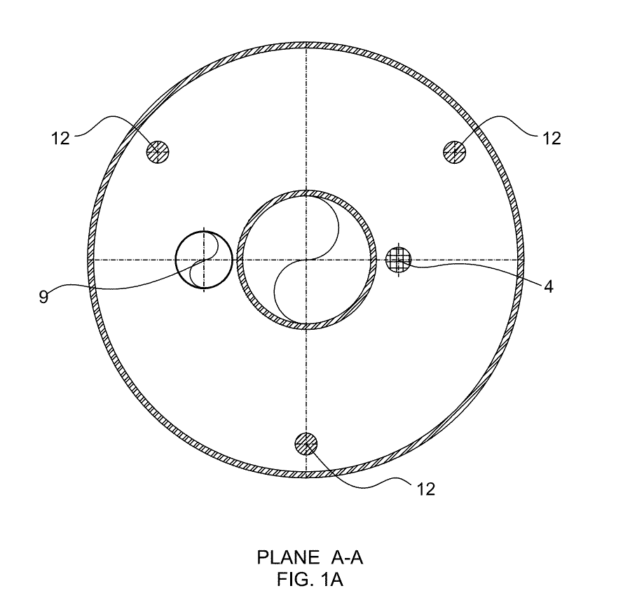

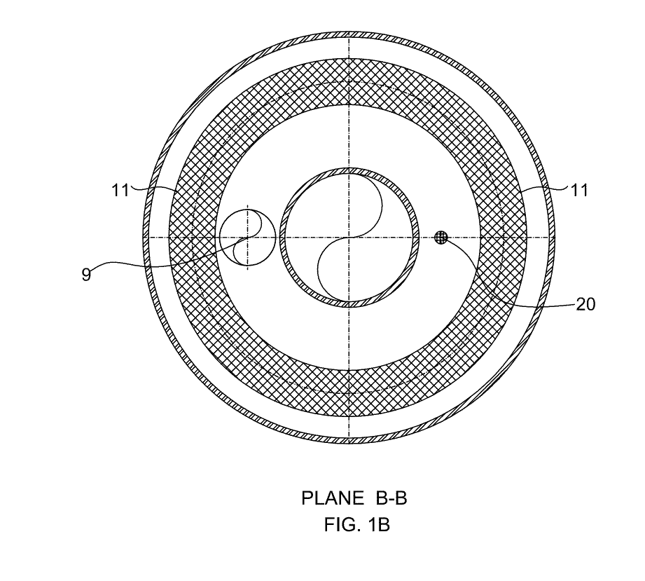

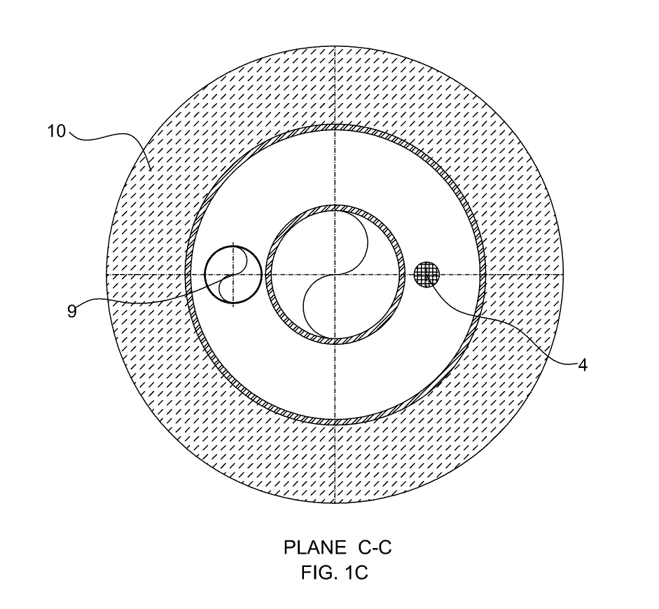

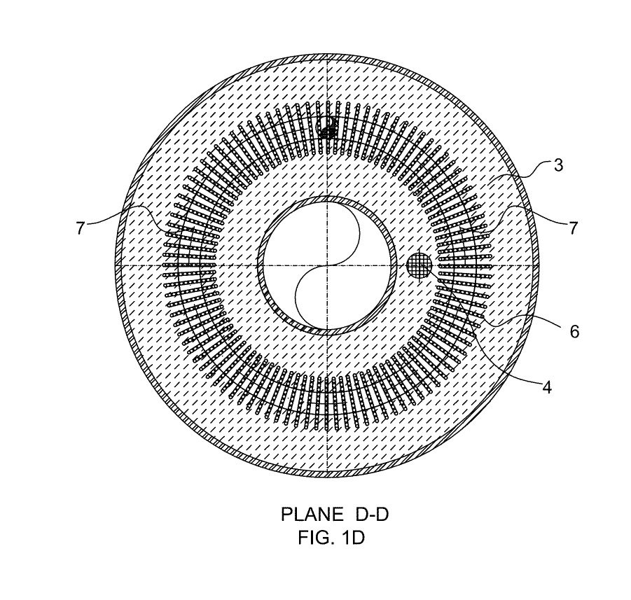

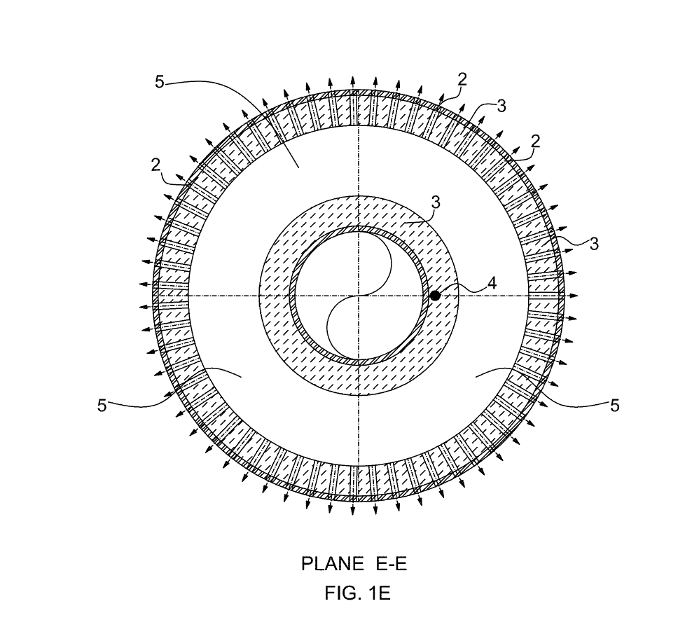

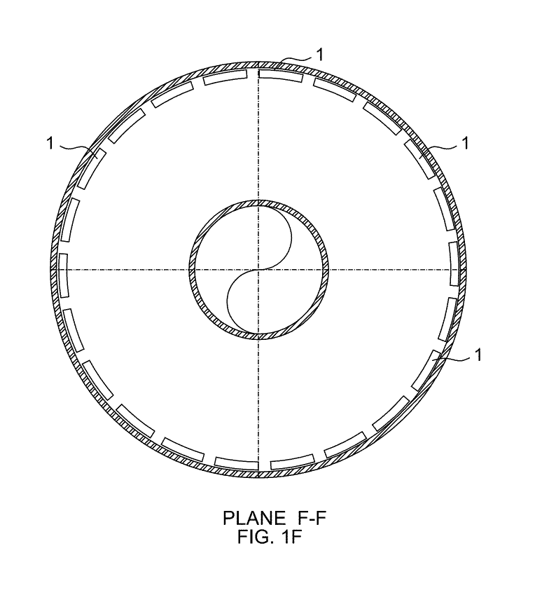

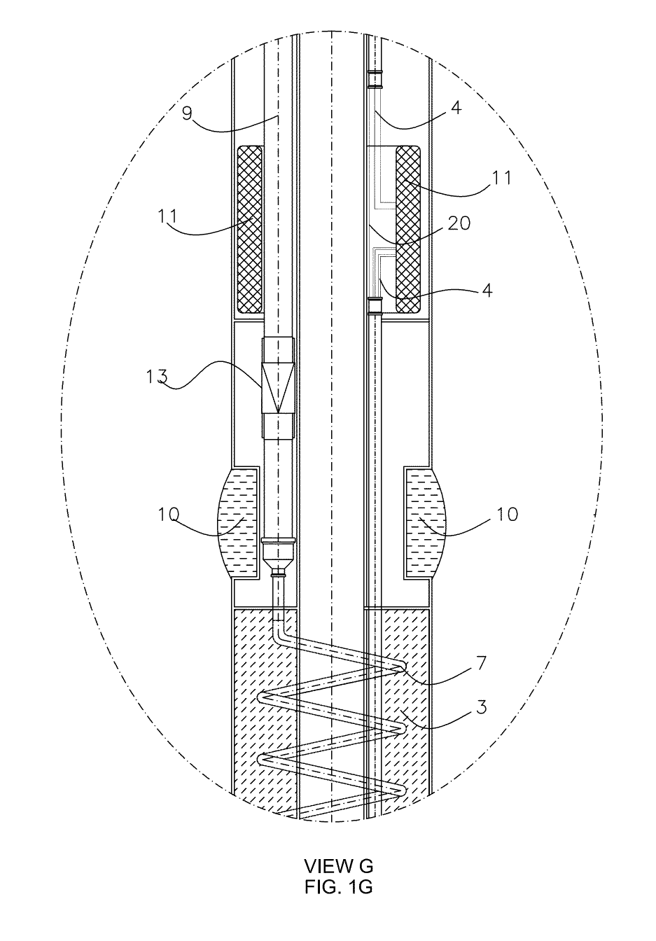

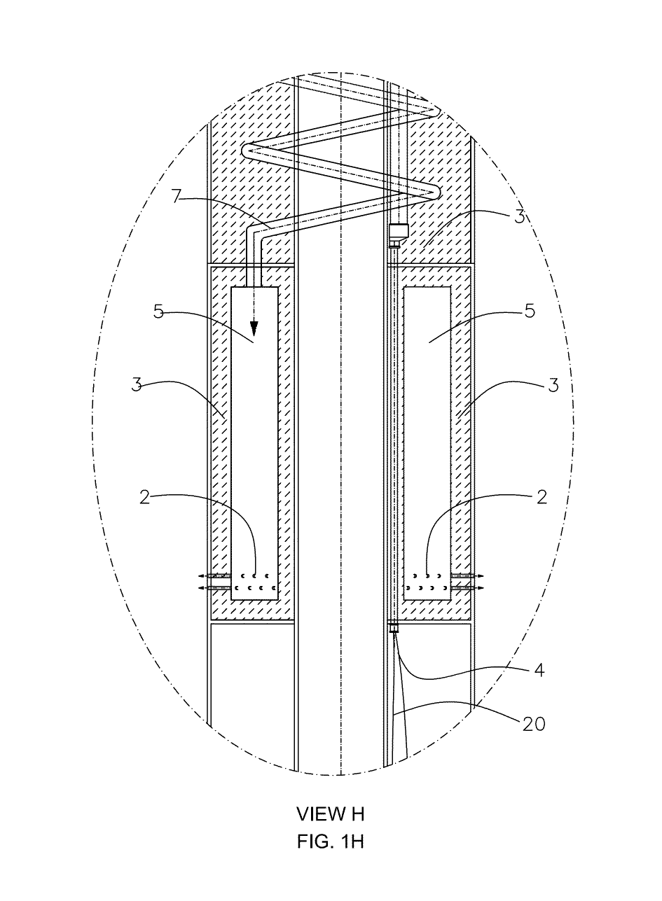

FIG. 1 shows the modules 14, 15, 16, 17, 18 and 19 of the Armadillo. All sectional views of FIG. 1 shows an annulus space in the center of the Armadillo. FIG. 1 also shows a steel frame 8 covering the whole equipment and steel bases separating one module from the other.

Each module has a specific function described below:

### 1. Support and Traction Module

This module provides support and traction to the underground equipment by means of reinforced cylindrical bars 12 with steerable joints.

FIG. 1A shows three cylindrical bars 12 which are fixed at the base of the unit 14.

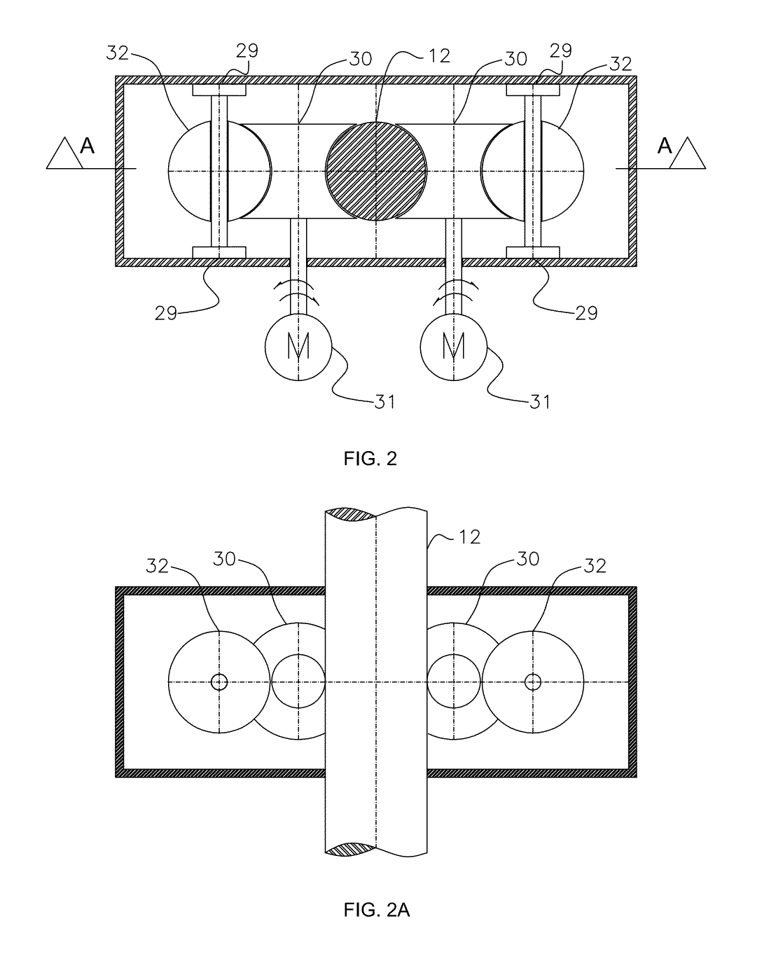

FIG. 2 is a support and traction unit that is used to move the cylindrical bars 12 up and down and so moving the Armadillo. Each cylindrical bar has two synchronized motors 31 that runs a steel pulley 30. Two support spheres 32 are used to stabilize the motors axis and have rollings 29 that may also permit an adjustment of the contact between the steel pulley and each bar. The movement speed is controlled by the control unit 22.

FIG. 2A is a side view of the support and traction unit.

### 2. Energy Feeder Module

This module is responsible for delivering electric power to several parts of the Armadillo. Using a flexible electrical cable 4, this module receives the energy from the power grid or a power generator 33. The cable 4 is connected to the distribution box 23 that feeds the energy power and control unit 22. The control unit 22 is connected to the Conductor Launching Equipment using an electrical swivel joint 21. An oscillator circuit is used to convert the DC current to a high frequency AC needed by the induction furnace.

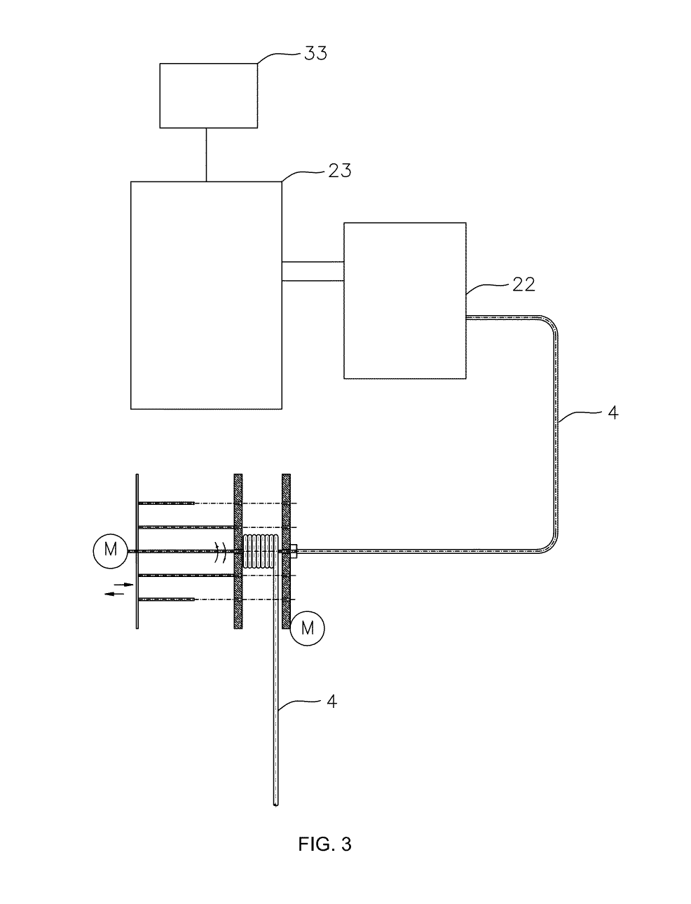

FIG. 3 shows the power grid or power generator 33 connected to the distribution box 23 that feeds an electric power and control unit 22 which transmits the energy through a flexible cable 4 using controlled current and voltage to the electrical and electronic parts of the remaining modules.

FIG. 1A shows the cable 4 that connects the equipments of FIG. 3 to the transformers and oscillator unit 11.

FIG. 1B shows unit 15 where the toroidal transformers and the oscillator unit 11 that receives low DC current and high voltage energy and converts it to controlled AC currents, voltages and frequencies.

FIG. 1G also shows the input and output cables 4 passing through the Support and Traction unit 14 before it reaches the transformers and oscillator unit 11.

### 3. Alloy Feeder Module

This module is responsible for receiving the alloy granules from the container and injecting them continuously into the induction furnace 7 by means of a high pressure flexible hose 9 previously wound in the Conductor Launching Equipment, described below. The flexible hose feeds the granules into a controlled pump 25 connected to the Conductor Launching Equipment using a mechanical swivel joint 21. The hose carries the granules to the furnace inlet.

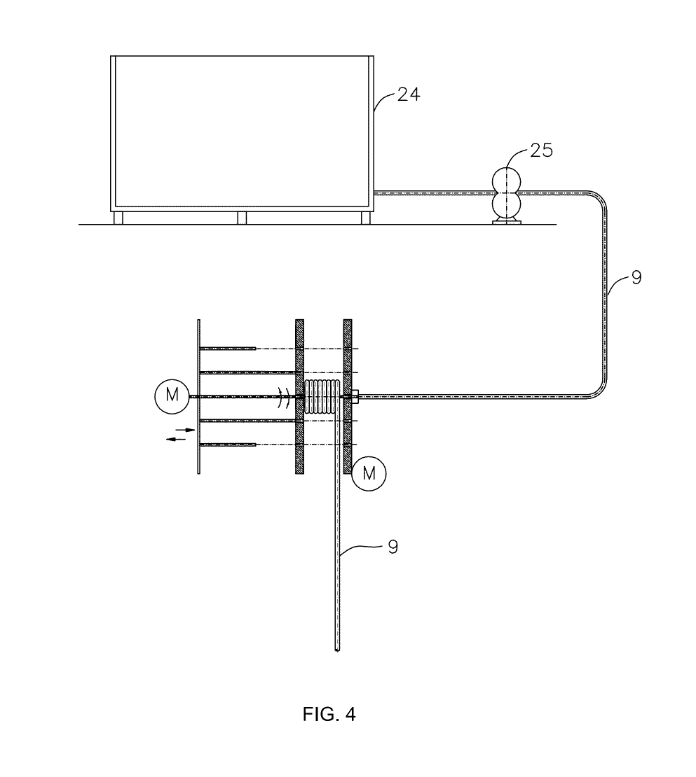

FIG. 4 shows an alloy granules container 24, a pump 25 with a controlled feed rate and the flexible hose 9.

FIG. 1A shows the hose 9 that connects the equipments of FIG. 4 with the feeder valve 13 in FIG. 1G.

FIG. 1G also shows the hose 9 passing through the Support and Traction unit 14 before it reaches the feeder valve 13 in the furnace inlet.

Conductor Launching Equipment

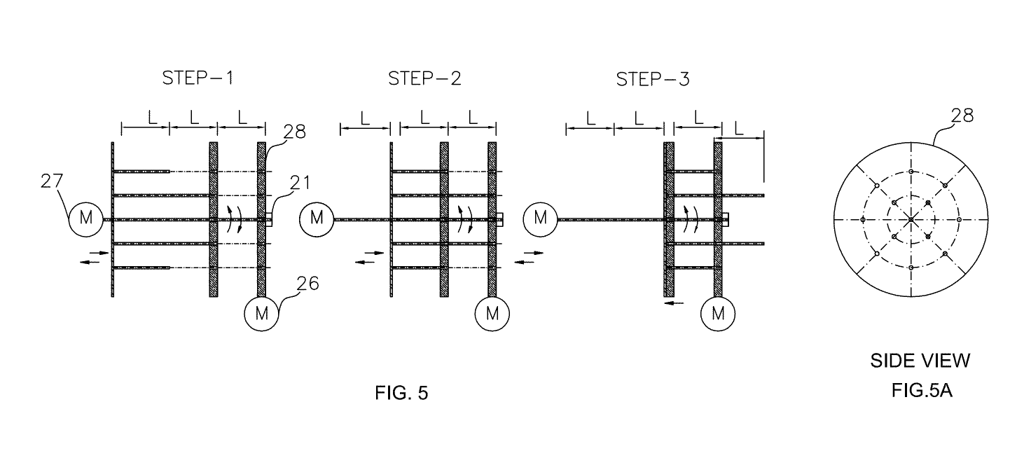

The Energy Feeder Module and the Alloy Feeder Module use a mechanism to launch and pick up a flexible conductor (electrical cable or hose) as shown in FIG. 5. The conductor is connected to its source continuously throughout the production process. To accomplish this, a swivel joint 21 is used. The swivel joint must be sealed when used for the hose launching equipment.

A controlled bar insertion mechanism is used to control the levels of the windings of hose or cable. These bars are responsible for holding the respective concentric layers of the conductor in order to avoid overweight. They are inserted or removed using the motor 27 in accordance to the next conductor layer to be coiled or uncoiled using the motor 26. The number of layers depends on the length, the diameter and the desired weight distribution for the conductor.

Synchronized launching and pick up control is needed in a long stretch of continuous cable and/or hose.

FIG. 5 shows an example of a three step bar mechanism for launching a flexible conductor and three layers of coiled conductor using a reel 28 with shaft length L. The control unit 22 controls this mechanism through the reel rotating motor 26 and the support bars motor 27.

FIG. 5A is a side view of the reel 28 and shows an example of the concentric holes where the supporting bars are inserted or removed.

### 4. Flatting Module

This module 16 is responsible for the straightening and the final adjustment of the duct's internal dimensions. It is also responsible for hardening the coat through the control unit 22. It uses a saucer shape hard ceramic ring 10 (such as Boron Carbide), to give the final diameter of the coated hole. The ring 10 is external to the steel frame. Its maximum diameter must be equal to the inner diameter of the coated hole.

FIG. 1C shows a hard ring 10. The ring has a saucer shape as shown in FIG. 1G.

### 5. Double Helical Induction Continuous Furnace Module

The hose 9 is connected to the furnace inlet through a safety feeder valve 13 used to avoid liquid alloy reflux. The Furnace Module 17 is responsible for heating and melting granules of metal alloy using helical magnetic field under controlled conditions.

The behavior of the helical magnetic field was first observed in the doctoral research of Dr. Mehreen Mahmud¹ in 2010.

The induction furnace consists of a hollow helical ceramic cylinder 7 wound by an inductor wire 6, made of tungsten, for example. The refractory 3 is responsible for the electrical insulation of the winding and the thermal insulation of the furnace.

The axis of the induction magnetic field must be the same axis of the hollow helical ceramic cylinder. The AC current is fed through the cable 4 into the winding in order to produce the helical magnetic field that travels through the helical cylinder. When the metal granules cross the energized winding the helical magnetic field will induce currents that gradually melt the alloy granules in the cylinder up to the desired temperature reached at the furnace outlet in the end of the helical cylinder. The liquid alloy is then injected into the reservoir 5.

FIG. 1D shows the hollow helical cylinder and the winding 6 encased in a refractory material 3.

FIG. 1G shows the connection between the induction furnace 7 inlet and the feeder hose 9.

FIG. 1H shows the connection between the induction furnace 7 outlet and the liquid alloy toroidal reservoir 5.

FIG. 2 is a 3D illustration of the helical induction furnace. It is just to give a better idea of the shape of the furnace and its coil. The diameter, length and number of turns of the furnace and of the winding are defined according to a desired specific application.

### 6. Alloy Ejection Module

This module 18 is responsible for ejecting the liquid metal alloy under controlled conditions in order to coat a section of the cylindrical hole. This module also acts as a lung, giving greater flexibility on the production and consumption of the metal alloy.

The reservoir 5 acts as a lung and must be large enough to reduce the effects of turbulence caused by the incoming flow from the furnace and to act as a buffer tank aimed at easing the operation of the Armadillo.

The liquid alloy is ejected through a series of ejection holes 2 at the bottom of the reservoir 5. The number of ejection holes 2 must be enough to assure a uniform and controlled flow rate. The ejection holes and the reservoir are lined with refractory material 3. Other designs for this module with different ejection hole shapes and directions may be defined according to specific applications.

FIG. 1H shows the furnace 7 connected to a toroidal reservoir 5 lined with refractory material 3 which stores the liquid alloy. It also shows the energy cable 4 and the signal cable 20 that connects this module to the monitoring and control module.

FIG. 1E shows the distribution of the ejection holes 2 at the base of the toroidal reservoir 5. It also shows the direction of the liquid alloy after it leaves the equipment.

### 7. Monitoring and Control Module

This module is responsible for monitoring and controlling the Armadillo during its coating work. It is also responsible for controlling the speed and direction of the Armadillo and several data from other modules such as heat transfer between the rock and the coating and the alloy flow rate. It consists of a control unit 22, actuators, electronic circuits and programs which are responsible for the synchronization and automation of the Armadillo. Its main controlling parameters are the speed of the Armadillo, the alloy ejection flow rate, the alloy feed rate, the coating cooling rate, the thickness and the quality of the coat, the electrical parameters (current, voltage and frequency) of the induction furnace and the continuity of the coating process.

The controlled sensors and actuators are installed inside the body of the Armadillo. For example, ultrasound sensors are used to verify the actual volume of the cylindrical hole section, which is the average volume of each segment of the hole that must be filled by the Armadillo. This segment volume includes possible crumbling, pores, and fractures to be sealed.

The control unit 22 is installed in a control room, typically near the power distribution box. It keeps Armadillo's speed synchronized with the feeder modules and the ejection module.

FIG. 1F shows the sensors 1 which are responsible for collecting data of the coating process.

FIG. 1G shows a signal cable 20 which is responsible for connecting the sensors 1.

### Description of the Continuous Tubular Coating Process of Use the Armadillo

The Armadillo equipment produces a continuous, joint-less metallic coating for a cylindrical hole with uniform diameter. The coat is produced directly on the inner surface of the hole and it can be done while drilling. The equipment's dimensions are defined by the cylindrical hole diameter and desired coating thickness.

During its operation, the Armadillo executes the coating work, monitors and adjusts its thickness and quality in order to create a tubular coating with a defined inner diameter. As the Armadillo moves through the hole, the coating process continues. The monitoring and control module evaluates the next section to be filled, while the ejection module fills the section already evaluated with liquid alloy prepared by the induction furnace.

The drilling and coating processes can proceed continuously in parallel, independently of each other. In this case, a rotary drilling rig must be used, by means of which the rocks are perforated by the action of rotation and the weight applied to an existing drill bit at the end of the drill string. The drill string of this rig pass through the central inner diameter of the Armadillo. It is assumed that the drill bit must use reamers and must have a single diameter throughout the whole perforation process. So the hole diameter will be larger than the drill bit diameter to allow the return of the drill bit through the coated hole.

During drilling, rock fragments are removed continuously using an upward stream of air (or some other fluid) which is injected downward through the drill string up to the drill bit. This upward stream carries these rock fragments through the annular space existing between the cylindrical hole and the drill string external diameter. This upward stream should continue and also cross the Armadillo through the annular space between its central inner diameter and the drill string external diameter. The fluid injection pressure, the drill weight, and the rotational speed parameters are very important when defining the size range of the rock fragments to be brought to the surface. By controlling these parameters, fragments larger than this annular space shall be crushed by the drill bit before reaching the Armadillo. After passing through the Armadillo, the upward stream goes to the surface using the annular space formed by the coated tube inner diameter and the drill string external diameter.

When removing the drill bit for maintenance or replacement, the Armadillo must first be removed in order to make way for the drill bit. Otherwise the removal of the Armadillo does not require removal of the drill bit.

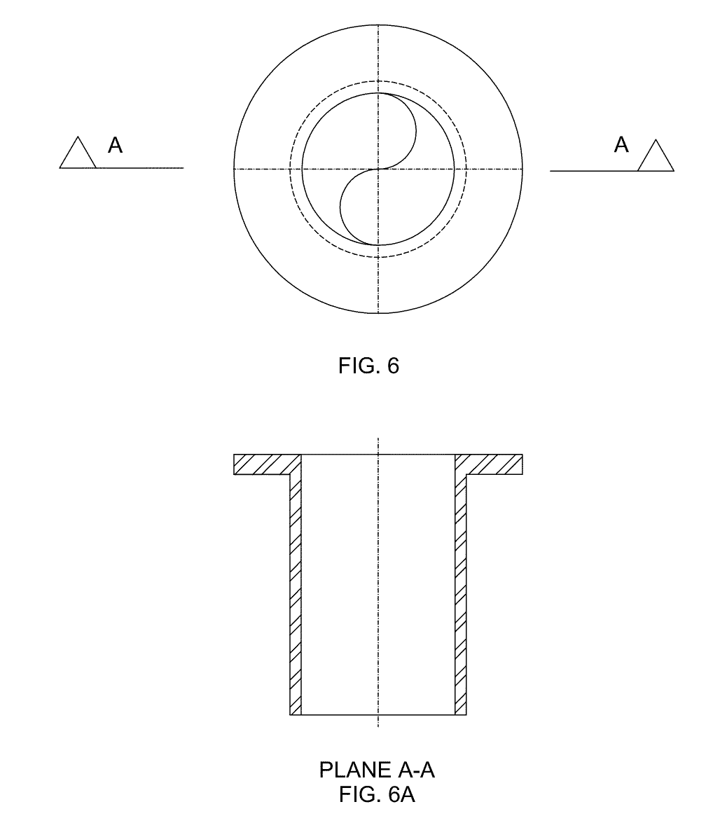

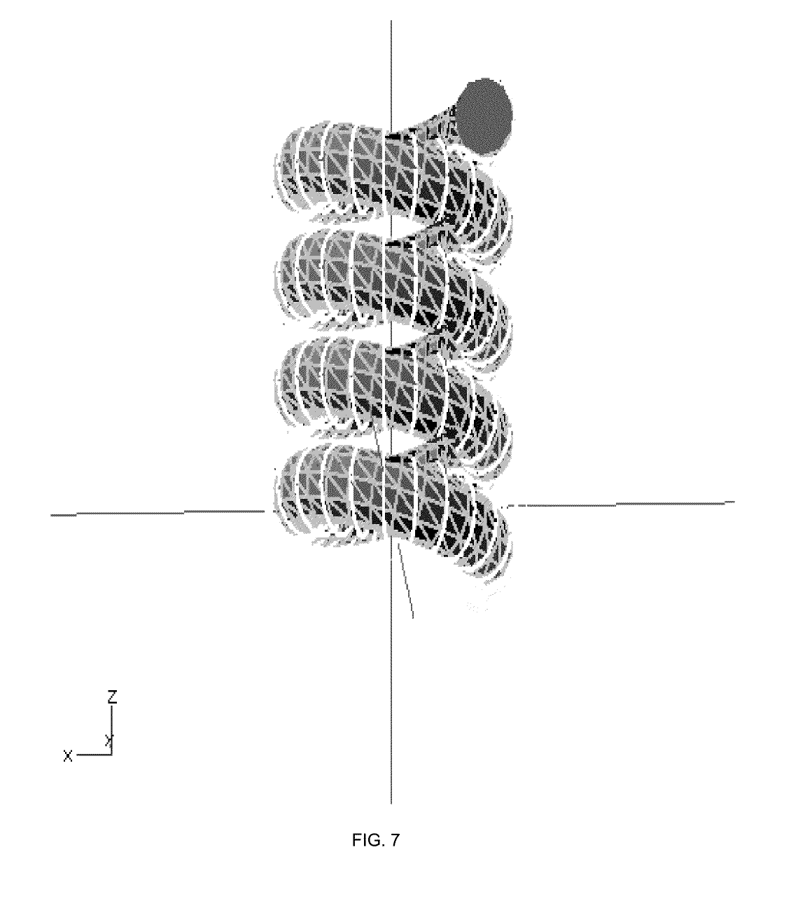

Before starting the coating process, a solid metal alloy ring FIG. 6 and FIG. 6A must be placed in the hole to center the initial position of the Armadillo and help sustain the coated tube.

During operation of the coating process, at about ¾ of the Armadillo is in contact with the coated cylindrical hole and the remainder of it is centered in the uncoated cylindrical hole. This keeps the monitoring and control unit FIG. 1F and the ejection holes 2 of the ejection module FIG. 1E correctly centered in relation to the hole.

The described process uses a metal alloy in the form of granules (for example, Al 6061 up to 15% in the amount of SiC 10μ, with granules less than or equal to 10 mm). The particle size range of the granules to be used in the Armadillo depends on the dimensions of the equipment used for coating. The grains are sucked from a container 24 by a pump 25 and injected into the furnace 7 by means of a supply hose 9, at a controlled flow rate. This material enters the Armadillo and passes through a feeder valve 13 that provides access to the double helical induction furnace. The induction heating process² continues in the furnace where the alloy is melted and poured into the reservoir 5 at a temperature of 5% to 8% above its melting point (around 1000K in the case of Al alloy 6061). This overheating is required so the liquid alloy reaches a viscosity sufficient for filling the pores and sealing the rock. In the reservoir the liquid alloy is continuously ejected, in a controlled flow, to the hole wall.

When the liquid alloy reaches the hole wall, it starts to solidify. The heat exchange is fast due to the relation of the mass of the Earth to the mass of the liquid alloy. It obeys Newton's law of cooling³.

q=h(T_{alloy}−T)

where q=heat flux, h=heat-transfer coefficient of the rock, T_{alloy}=liquid alloy temperature, and T=Earth's temperature, at the depth considered.

The alloy is ejected continuously to the cylindrical hole segment to be filled. The liquid alloy diffusion in the rock and the solid metal on the grooves of the cylindrical hole inner wall (made by the drill) will be the main components in providing support for the coating.

### INDUSTRIAL APPLICABILITY AND ADVANTAGEOUS EFFECTS

When using this equipment for oil and gas exploration, for example, it delivers a well-bore by isolating the casing and the formation. Each foot of borehole is drilled and cased off simultaneously, eliminating the need for separate casing. When the drill has produced the required depth, the well-bore is ready for production and does not demand a cementing phase. This equipment may be used while drilling, resulting in a unique action that seals well-bore pores, reduces fluid loss, and may improve performance compared to conventional drilling systems.

When using this equipment to pass a metallic tube through the soil, it may be more friendly to the environment than the traditional pipeline laying, once it is not necessary to cut the ground to insert the tubes.

### NON PATENT CITATION

1—Mehreen Mahmud, European VLBI, Ireland, The Behavior of the Helical Magnetic Field, Doctoral Research, 2010.
2—Jean Callebaut, European Cooper Institute & Laborelec, Induction Heating, 2007.
3—Bird, Stewart and Lightfoot, U of Wisconsin, Transport Phenomena, John Wiley & Sons, 2007.

### DRAWINGS INFORMATION TABLE

1. SENSOR
2. EJECTION HOLES
3. REFRACTORY
4. SIGNAL AND ENERGY FLEXIBLE CABLES
5. LIQUID ALLOY RESERVOIR
6. WINDING OR INDUCTOR WIRE
7. FURNACE OR HELICAL CYLINDER
8. STEEL FRAME
9. HIGH PRESSURE FLEXIBLE HOSE
10. HARD CERAMIC RING
11. TRANSFORMERS AND OSCILLATOR UNIT
12. SUPPORT AND TRACTION BAR
13. FEEDER VALVE
14. SUPPORT AND TRACTION UNIT
15. ENERGY FEEDER UNIT
16. FLATTING MODULE
17. DOUBLE HELICAL INDUCTION FURNACE MODULE
18. ALLOY EJECTION MODULE
19. MONITORING AND CONTROL UNIT
20. SIGNAL CABLE
21. SWIVEL JOINT
22. ELECTRIC POWER AND CONTROL UNIT
23. POWER DISTRIBUTION BOX
24. ALLOY GRANULES CONTAINER
25. PUMP
26. REEL ROTATION MOTOR
27. SUPPORT BARS MOTOR
28. REEL
29. ROLLING
30. STEEL PULLEY
31. STEEL PULLEY MOTOR
32. SUPPORT SPHERE
33. POWER GRID OR POWER GENERATOR

1. THE ARMADILLO EQUIPMENT
The project and design of the modules and the flexibility to compose them.

2. DOUBLE HELICAL INDUCTION CONTINUOUS FURNACE
A continuous induction furnace model and its design, optimizing space and heat transfer.

3. CONDUCTOR LAUNCHING EQUIPMENT
Uninterrupted power and fluid mass supply from a source to a remote destination at variable distance.
